(19) United States
(12) Patent Application Publication
(10) Pub. No.: US 2025/0363321 A1
(43) Pub. Date: Nov. 27, 2025

(54) MULTI-SEGMENT EDGE CORRECTION

(71) Applicant: Kateeva, Inc., Newark, CA (US)

(72) Inventor: Christopher Hauf, Belmont, CA (US)

(73) Assignee: Kateeva, Inc., Newark, CA (US)

(21) Appl. No.: 19/108,132

(22) PCT Filed: Aug. 22, 2023
(86) PCT No.: PCT/US2023/030820

§ 371 Date: Feb. 28, 2025

Related U.S. Application Data
(60) Provisional application No. 63/374,463, filed on Sep. 2, 2022.

(51) Int. Cl. G06K 15/02; B41J 3/28; B41M 5/00; G06K 15/10

(52) U.S. Cl. CPC G06K 15/1872; G06K 15/102; G06K 15/1836; B41J 3/28; B41M 5/0047

(57) ABSTRACT

Methods of creating an image file of a film for deposition by an industrial inkjet printer are described herein, including obtaining a base image; defining a raster pixelation of the base image; populating a map table with indices of an edge profile table; defining an edge treatment zone using the raster pixelation; defining an edge treatment profile representing a thickness profile to be applied to the layer at an edge thereof; populating the edge profile table with values of an image scale representing the edge treatment profile; obtaining the indices from cells of the map table corresponding to the edge treatment zone; retrieving an image value from the edge profile table for each index obtained from the map table; and storing the image values in an image file.

### CROSS-REFERENCE TO RELATED APPLICATIONS

This patent application claims benefit of U.S. Provisional Patent Application No. 63/374,463 filed Sep. 2, 2022, which is entirely incorporated herein by reference.

### BACKGROUND

Industrial inkjet printers are used to apply materials to large substrates to form devices of all kinds. The substrates can be rigid or flexible, thick or thin, and can be made of an array of materials. The most common types of substrates used in this way are substrates made of various types of glass, which are processed to make electronic displays such as televisions and displays for smart phones. The substrates are typically large panels that are constructed and then divided into individual products. Construction of the features and devices on the panels is performed by depositing microscopic droplets of a print material at precise locations on the panel and solidifying the deposited material. The material typically forms layers covering regions of the panel. The layers may be light generating layers, frequency shifting layers, or protective layers.

Controlling deposition of the material is typically done by determining coordinates where droplets of the material are to be deposited. The coordinates of very large numbers of droplets are determined from a print plan that specifies a layer to be formed. The print plan specifies the thickness of the layer at every location of the layer. The specified thickness can vary in order to compensate for spreading and stacking behavior of the liquid droplets and dimensional changes during solidification of the material. In particular, edges are frequently specifically engineered with corrective thickness profiles to achieve a certain effect in the layer at the edge. Given the vast numbers of droplets to be printed on the panel to form a layer, there is a need for a way to design edge correction profiles that can be quickly converted to print plan data.

### SUMMARY

Embodiments described herein provide a method of forming an image file of a layer of material to be formed on a substrate by inkjet printing, the method comprising obtaining a base image; defining a raster pixelation of the base image; populating a map table with indices of an edge profile table; defining an edge treatment zone using the raster pixelation; defining an edge treatment profile representing a thickness profile to be applied to the layer at an edge thereof; populating the edge profile table with values of an image scale representing the edge treatment profile; obtaining the indices from cells of the map table corresponding to the edge treatment zone; retrieving an image value from the edge profile table for each index obtained from the map table; and storing the image values in an image file.

Other embodiments described herein provide a method of forming an image file of a layer of material to be formed on a substrate by inkjet printing, the method comprising obtaining a base image; defining a raster pixelation of the base image; populating a map table with indices of an edge profile table; defining an edge treatment zone using the raster pixelation; defining an edge treatment profile representing a thickness profile to be applied to the layer at an edge thereof; populating the edge profile table with image values representing the edge treatment profile; obtaining the indices from cells of the map table corresponding to the edge treatment zone; retrieving an image value from the edge profile table for each index obtained from the map table; and storing the image values in an image file.

Other embodiments described herein provide a method of defining edge treatment of a layer of material to be formed on a substrate by inkjet printing, the method comprising displaying a base image of the layer on a display of a digital processing system; accepting user input of an edge treatment zone, defined using the raster pixelation, from an input of the digital processing system; accepting user input of an edge treatment profile, representing a thickness profile to be applied to the layer at an edge thereof, from the input of the digital processing system; and using the digital processing system to define a raster pixelation of the base image; populate a map table with indices of an edge profile table; populate the edge profile table with image values representing the edge treatment profile; obtain the indices from cells of the map table corresponding to the edge treatment zone; retrieve an image value from the edge profile table for each index obtained from the map table; and store the image values in an image file.

Other embodiments described herein provide a method of defining edge treatment of a layer of material to be formed on a substrate by inkjet printing, the method comprising obtaining a base image; defining a raster pixelation of the base image; populating a map table with indices of an edge profile table; accepting digital user input defining an edge treatment zone based on the raster pixelation; accepting digital user input defining an edge treatment profile, the edge treatment profile representing a thickness profile to be applied to the layer at an edge thereof; populating the edge profile table with image values representing the edge treatment profile; obtaining the indices from cells of the map table corresponding to the edge treatment zone; retrieving an image value from the edge profile table for each index obtained from the map table; depositing the image values in an image table; and outputting the image table to an image file.

### BRIEF DESCRIPTION OF THE DRAWINGS

FIG. 1 is a flow diagram summarizing a method according to one embodiment.

FIG. 2 is a screen view of a graphical user interface according to another embodiment.

### DETAILED DESCRIPTION

Methods are described herein of displaying and specifying edge treatments for a layer of material to be formed on a substrate. The layer is to be formed by printing a material using microscopic droplets and then solidifying the material. The print material is typically a curable material that solidifies by exposure to radiation of one form or another. Ultraviolet radiation is commonly used, but infrared can also be used, and thermal energy can also be applied. The print material is formulated with a density and viscosity to provide a targeted deposition behavior in the printer and spreading behavior when deposited on the substrate. The droplets are positioned, based on the spreading behavior of the material, to spread and coalesce to form a film. Thickness of the film is related to density of the deposited droplets, so a film having a desired thickness can be related to a certain droplet spacing on the substrate.

It is often desired to adopt a certain print pattern at the edge of a layer to achieve a sharp smooth edge of the layer. Sometimes, for very thin layers, printing a uniform density of droplets right to the programmed edge of the layer results in a non-uniform edge, especially after solidifying the layer, due to surface effects at the layer edge. For this reason, it is often desired to program a taper, bulge, or other edge treatment.

In some cases, the substrates upon which films are printed can be as large as 8 m², and the droplets used to form the film may cover an area as small as 50 μm², meaning that, in theory, one substrate could have 1.6×10¹¹ possible locations to apply a droplet of print material. If several products are formed using such a substrate, each product needing an edge adjustment during the print process, potentially millions of computations would be needed to determine thickness at every possible droplet location so the film edge can be formed. If multiple such films are to be formed on the substrate for each product, the computation resources required to directly compute all the edge thickness values quickly multiplies. The edge treatments contain large redundancy, however, so computing an edge profile, like a transverse slice of the edge treatment, and just copying that profile throughout an edge treatment zone would be much more efficient than computing every location.

In the methods described herein, an edge profile is computed and stored in a 1-dimensional edge profile table. A look-up process is used to retrieve thickness values from the edge profile table for edge treatment zones of a film. The look-up process is much more computationally efficient than calculation and enables fast conversion of user design input regarding edge treatment of a film to an image file of the film that can be processed into a print plan for a printer to execute.

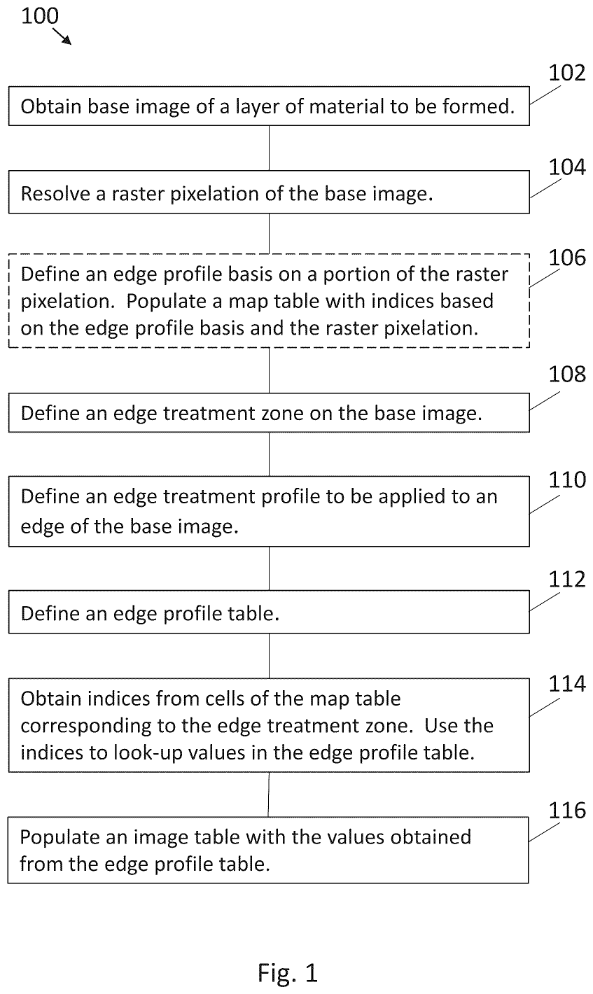

FIG. 1 is a flow diagram summarizing a method 100 according to one embodiment. The method 100 is a method of quickly applying an edge treatment to a base image to form an image file of the base image with the edge treatment. At 102, a base image is obtained of a layer to be formed on a substrate. The layer to be formed can have any convenient shape or configuration, and can be multiple layers spaced apart on the substrate. The base image is obtained as an electronic file, which can be in any format or use any convention to define a shape. The file contains data that defines the shape of the base image, and may contain data defining a thickness, or multiple thicknesses, of a layer matching the shape of the base image to be formed on a substrate. Thickness data is optional. The base image can be a template image of the layer to be formed without any details of edge treatments or details to be formed as part of the layer. In some cases, the base image is a vector graphics image, while in other cases the base image is a raster graphics image.

At 104, a raster pixelation of the base image is resolved. The raster pixelation emerges from a coordinate system defined on the base image. Where the base image is a vector graphics image, the vector graphics data is transformed into a raster pixelation at an appropriate resolution. Where the base image is a raster graphics image, the raster graphics data may be rendered at the resolution to be used in planning formation of the film.

The raster pixelation includes coordinates of pixels defined from the base image. The pixels are small regularly shaped and sized abutting regions that together represent the base image. The pixels are generally defined based on characteristics of an apparatus to be used to form the layer on the substrate. Each pixel has a coordinate and a size. Each pixel may also have a thickness. The representation of thickness can be a value of an image scale, such as grayscale. The thickness of each pixel may be resolved from a single thickness specification for the layer to be formed in the shape of the base image or may be specified in any convenient way. For example, if the layer to be formed is to have a uniform thickness of 8 μm (excluding any edge treatment), each pixel might have a thickness of 8 μm. The thickness of each pixel can be represented in any convenient numerical way. Thickness data associated with pixels is optional.

The raster pixelation can refer to, provide a basis for, and/or define rows and columns of a map table containing numbers that represent the layer thickness at each pixel location, for example as a numeric array in a digital memory. The raster pixelation can also refer to, provide a basis for, and/or define rows and columns of an image table, different from the map table, containing numbers that represent the layer thickness at each pixel location. Where a separate map table and image table are used, the map table will contain data used by an algorithm to resolve image values to store in the image table to represent thickness of the film to be formed on the substrate. Thus, the coordinate of each pixel can be a row/column coordinate of the map table and/or the image table, and the representation of thickness for that pixel can be an image value located in the map table and/or the image table at the row/column coordinate of the pixel. The image value can be a physical thickness, such as 8 (μm as in the above example), or the image value can be a scale value representing a thickness within a range, where extremity values of the scale represent the end points of the thickness range. As a digital array, the image value can be stored at a memory address corresponding to the row/column coordinate of the image value in the map table and/or the image table.

The raster pixelation may include pixels defined by the raster pixelation. The size of each pixel can be related to the print pitch of a printer to be used to form the layer on the substrate. The print pitch is effectively how many distinct dots of print material the printer can deposit in a given distance interval. In some cases, the print pitch is essentially the size of a dot of print material the printer deposits, and the print pitch can be the same in more than one direction, or can be different in all directions. Each pixel can represent one print pitch, or an integer number of print pitches or a rational multiple of a print pitch, and can be thought of as having a size equal to one print pitch, which in some cases can be the size of one printed droplet of print material. Alternately, each pixel can represent more than one print pitch. In such cases, each pixel represents a region of the substrate surface onto which droplets are deposited. The raster pixelation forms a basis to represent the film layer to be formed on the substrate according to location and thickness of the film at each location. In a map table and/or an image table, the pixels can be represented by cells dimensioned on the coordinates of the raster pixelation. As noted above, each location of the substrate as defined, or referred to, by the raster pixelation can be a location where one droplet of print material can be deposited, or each location can be a region onto which droplets are to be deposited.

At 106, an edge profile basis can be defined. The edge profile basis is optional, but can help reduce computational burden by limiting the area in which an edge treatment can be designed and applied. Where an edge profile basis is not used, the edge profile basis effectively covers or includes the entire base image area. The edge profile basis is a map defined on a portion of the raster pixelation (e.g., a subset of the pixels, or a subset of the map table that represents the film, or a subset of the coordinates) that represents an area of the base image where an edge profile can be applied to accomplish an edge treatment of the base image. The edge profile basis can be populated with a collection of indices to an edge profile table that will be populated with edge profile thickness values. The edge profile table is a 1-dimensional table that has edge thickness image values for a particular edge treatment. The edge profile table, and application and use thereof, is further described below.

The edge profile basis may be a set of numbers that define an area of the base image included in the edge profile basis. For example, the edge profile basis may include an edge identifier (a numeric or alphanumeric value that refers to an edge of the base image), a start location (a numeric value that identifies a coordinate on the edge where the edge profile basis begins), an end location (a numeric value that identifies a coordinate on the edge where the edge profile basis ends), and a width (a numeric value that defines a distance from the edge of the base image covered by the area of the edge profile basis). For example, if a raster pixelation of a rectangular base image contains 1000 row coordinates and 1000 column coordinates, defining 1,000,000 pixels, and the base image has edges numbered “1” to “4”, an edge profile basis for the raster pixelation may contain the values “1, 200, 400, 200.” In this example, the width is defined as a number of pixels, but the width could be defined in units of distance, for example microns or millimeters. In other cases, the edge profile basis can be a single point definition, such as a centroid of the base image, which can be used to define, symmetrically, the area where the edge treatment can be performed. In other cases, the edge profile basis can be a single point definition, coupled with a depth or width. In other cases, the edge profile basis can be a shape definition that can be applied as a mask. In other cases, the edge profile basis can be a shape definition that can be applied as an anchor, such as a line or curve, to define the area where edge treatments can be applied.

The edge profile basis identifies a plurality of pixels, and may include the identified pixels. Each cell of the map table, at the coordinates of pixels identified by the edge profile basis, is populated, during creation of the raster pixelation, with an index value pointing to a location in an edge profile table to be used to apply the edge treatment in an edge treatment zone defined within the edge profile basis. The edge treatment zone is further described below. The index values are selected to be values that are not values of the image scale being used to specify thickness. In the grayscale example, index values would start at a number such as 257 to be outside the range of index values that define the grayscale. In this way, the entries of the edge profile table can differentiate image scale values of the base layer from image scale values for the edge treatment to be applied at the location.

The optional edge profile basis defines where an edge treatment can be specified, so the edge profile basis is constructed to have a size that can accommodate any extent of edge treatment that might be selected. Thus, the edge profile basis is like an envelope within which edge treatments can be specified and outside which edge treatments cannot be specified. As noted above, during creation of the raster pixelation, the cells of the map table corresponding to pixels covered by the edge profile basis (or really the entire area where edge treatments can be applied, for example the entire base image area if no edge profile basis is used) are populated with index values to be used to find image values for each pixel in a 1-dimensional edge profile table. The number of index values needed to populate the cells is determined from the number of pixels covered by the edge profile basis in a direction orthogonal to the edge associated with the edge profile basis. Thus, if an edge profile basis having a width of 10 mm is used with a pixel size of 10 μm, 1000 indices will be needed to provide the possibility of applying an edge treatment to the film in the entire area covered by the edge profile basis.

In one embodiment, the edge profile basis can be used to populate indices into a map table according to an erosion method. In the erosion method, cells of the map table, corresponding to pixels defined during raster pixelation of the base image and associated with the edge basis profile, are populated starting at the edge of the image and working inward from the edge until all the cells corresponding to the edge basis profile are populated. The cells can be populated one “row” at a time or one “column” at a time, in a manner parallel to the edge or perpendicular to the edge. When one “row” or “column” is populated, processing moves to the next “row” or “column.” Such methods can simplify processing because, in many cases, the index to be populated into the cell of the map table can simply be incremented when processing moves to the next “row” or “column.”

At 108, an edge treatment zone is defined on the base image using pixels of the raster pixelation. The edge treatment zone can be defined by specifying locations on the edge of the base image along with a width of the edge treatment zone. Multiple edge treatment zones can be defined on the base image. The edge treatment zone can have content that is the same as the edge profile basis, including edge identifier, start location, end location, and depth.

The edge treatment zone is a different object from the edge profile basis. As noted above, the edge treatment zone can have content that is the same as the edge profile basis, or it could have different content. Whereas the edge profile basis defines where an edge treatment can be specified, the edge treatment zone defines where an edge treatment is defined. Thus, an edge treatment zone can be within the area defined by the edge profile basis or can be coextensive with the area defined by the edge profile basis. The edge treatment zone cannot define an area larger than the edge profile basis. It should be noted that more than one edge treatment zone can be defined on one edge profile basis. It should also be noted that, where no edge profile basis is used, edge treatment zones can be defined at any location of the base image, provided that a portion of the edge treatment zone coincides with an edge of the base image.

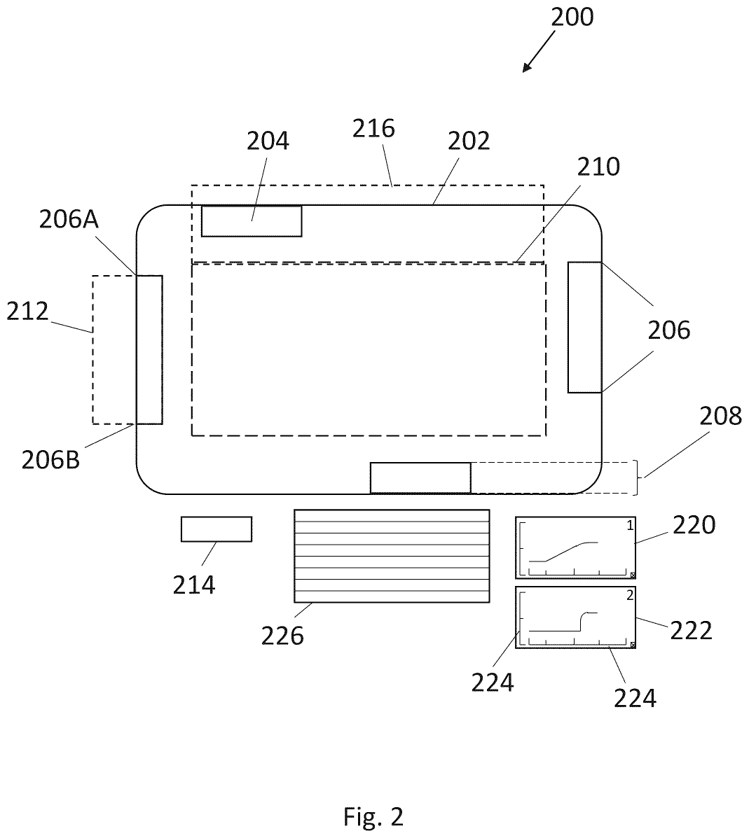

Edge treatment zones can be defined using a graphical interface. FIG. 2 is a screen view of one example. The view of FIG. 2 shows a base image 202 with a plurality of edge treatment zones 204 identified. The edge treatment zones 204 are specified by identifying boundary locations 206, a start location 206A and an end location 206B, on the edge of the base image 202 (using the coordinates defined by the pixel rasterization) to be boundaries of an edge treatment zone and by specifying a width 208 of the edge treatment zone. Each edge treatment zone can have the same width or they can all have different widths. Multiple edge treatment zones 204 are shown in FIG. 2 having different widths. The base image 202 of FIG. 2 has a quasi-rectangular shape with rounded corners, but any shape could be used. To aid the user in defining edge treatment zones, the edge profile basis can be shown at 210, so the user is aware of the limits beyond which an edge treatment cannot extend. Here, one edge treatment zone 204 is defined for each side of the base image 202, but multiple edge treatment zones 204 could be defined on a side of the base image 202, each with differing width if desired. The edge treatment zones 204 can be expressed mathematically as a set of values representing coordinates of the boundaries of the edge treatment zone 204 and a value representing the width of the edge treatment zone 204. Each edge treatment zone 204 can be represented electronically as an array instantiated with the values of the set.

A width is specified for each edge treatment zone. The width specifies the distance from the edge of the base layer over which the edge treatment is to be applied. The width is typically one numeric value for each edge treatment zone, and must be less than the width of the edge profile basis. For example, a width of 150 μm specifies that, for the respective edge treatment zone, the edge treatment to be applied will extend into the base layer a distance of 150 μm from the edge in a direction orthogonal to the edge. The width, along with the boundaries described above, determine which pixels defined by the raster pixelation are included in the edge treatment zone. As noted above, the 150 μm width (specified in any convenience numerical format) can be the same at the width of the edge profile basis on which the edge treatment zone is defined, or can be less than the width of the edge profile basis. For example, an edge treatment zone having a width of 150 μm can be defined on an edge profile basis having a width of 200 μm.

An edge treatment zone, and an edge profile basis, can be defined using a graphical mask process. The graphical user interface 200 shows a shape definition 212, which can be made by a user using any suitable function of the graphical user interface 200 (e.g. standard drawing functionality to make shapes of any kind). A user can create the shape definition 212 in a way that overlaps any portion of the edge profile basis. The overlapping zone can be established as an edge treatment zone. The user-drawn mask function can be activated by buttons or menu selections. For example, a button 214 can be provided to activate the user-drawn mask function. A mask can also be constructed by a user using another computer program and provided as a digital file that can be applied to the base image to define an edge treatment zone.

An edge profile basis can also be defined using a user-drawn, or user-provided mask. The graphical user interface 200 shows a second shape definition 216 (where a second shape definition is used, the shape definition 212 is a first shape definition), which can be made by a user as above. Where the second shape definition 216 overlaps any portion of the base image 202, an edge profile basis can be established. As with the edge treatment zones, the user-drawn mask function can be activated by buttons or menu selections, for example a button like the button 214. In this case, where a mask process is used to define an edge profile basis, where a user accepts an edge profile basis defined by a mask, acceptance can trigger population of the corresponding pixels in the map table with indices.

The mask can have any suitable shape. In the graphical user interface 200, the shape definitions are rectangular, but the user can use any shape drawing function to make a suitable shape definition, such as a polygon, regular or irregular, enclosed curved region, regular or irregular, or a stylized definition, such as a cloud shape.

It should be noted that an edge profile basis and an edge treatment zone both have the property that no portion thereof is larger, in a direction parallel to the edge of the base image, than the portion of the base image edge encompassed by the edge treatment zone of the edge profile basis. Thus, an edge treatment zone or edge profile basis, has a dimension that is widest at the edge of the base image encompassed by the edge treatment zone or edge profile basis, and no other portion thereof has a dimension, in a direction parallel to the encompassed edge, that is larger than the dimension at the encompassed edge. Accordingly, it should also be noted that an edge treatment zone or edge profile basis can have a dimension, in a direction parallel to the encompassed edge, that is smaller than the dimension at the encompassed edge. Where a user-defined or user-drawn shape definition has a dimensional feature that would create a dimension narrower, at the encompassed edge, than an internal dimension of the shape definition, in the direction parallel to the encompassed edge, the graphical user interface 200 can display an implied definition of the edge treatment zone or edge profile basis or the graphical user interface 200 can display a message to the user.

At 110, an edge treatment profile is defined. The edge treatment profile is a specification of how a film edge is to be shaped in one dimension orthogonal to the edge. The edge treatment profile can be applied to one or more edge treatment zones, and different edge treatment profiles can be applied to different edge treatment zones of a base image. An edge treatment profile applied to an edge treatment zone is applied at each edge location of the edge treatment zone between the start location and the end location of the edge treatment zone. Thus, an edge treatment zone can have only one edge profile applied to it. If more than one edge profile is needed, separate edge treatment zones are defined, one for each edge profile to be applied. As noted above, all such edge treatment zones can be defined on one edge profile basis. Alternately, of course, multiple edge profile bases can be defined on one base image, and various edge treatment zones, and corresponding edge profiles, defined on the various edge profile bases. In applying an edge treatment profile, the pixels corresponding to the edge treatment zone are identified, and the edge treatment profile is used to populate cells corresponding to the pixels.

The edge treatment profile can be specified in any convenient way. Fundamentally, the edge treatment profile specifies how the film thickness changes near the edge of the film to be formed corresponding to the base image. For example, the edge treatment profile may reflect a linear taper in thickness at the edge of the film. Such an edge treatment can be specified by a start position, a width or an end position, and a taper specification. The taper specification can be a start thickness and an end thickness, a start thickness and a slope, or an end thickness and a slope. The thicknesses can be specified in units of distance (i.e. microns) or as percentage of the base film thickness. So, for example, if the base film represented by the base image is to have a nominal thickness of 20 μm, an edge treatment profile can specify a linear taper in film thickness covering an area at the edge of the film, with a thickness of 100% of the nominal film thickness at a location 50 μm from the edge of the film, and a thickness of 50% of the nominal film thickness at a location 10 μm from the edge of the film. Such a taper specification would have a shape identifier signifying a linear taper, a start location of 10 μm, a start thickness of 50% (or 10 μm), an end location of 40 μm, and an end thickness of 100% (or 20 μm). Other methods of specifying edge treatment profiles can also be used. For example, curvatures can be specified using start location, end location, and radius of curvature (with positive and negative values indicating convex or concave curvature). Piecewise linear edge treatment profiles can also be specified as multiple tapers with different slopes and/or different thickness changes.

The graphical user interface 200 can display a representation of an edge treatment profile. One or more such representations can be displayed such that a graphical representation of a first edge treatment profile 220 is displayed, and simultaneously a graphical representation of a second edge treatment profile 222 can be displayed. Each graphical representation can have scale features 224, which can be the same or different according to the scale of the edge treatment to be applied using the edge treatment profile. Units of the scale features can be displayed, as well. Selection means, such as buttons and menu options can be used to activate display of the graphical representations of the edge treatment profiles. The graphical user interface 200 can also have a graphical system (not shown) for editing edge treatment profiles. The system can provide a template screen on which a user can draw, using any suitable drawing functions, a shape definition to be used as an edge treatment profile. The graphical system can transform the shape definition defined by the user into an edge treatment profile using scale information supplied by the user.

The graphical user interface 200 can also have data display and editing functions. For example, the graphical user interface 200 can use selection means, such as buttons or menu options, to display one or more tables 226 of data. The data can be any data relevant to the layer design displayed in the graphical user interface 200, such as dimensions, table contents, coordinates, thicknesses, and the like.

To identify the values to be populated corresponding to the pixels, at 112, an edge profile table is defined corresponding to the edge treatment profile. As indicated above, the edge profile table is a 1-dimensional table containing image values (representing thickness) representing an edge profile shape to be applied to the base layer. The edge profile table is a map-through table that transforms an index value to an image value. The cells of the edge profile table are populated with image values that represent layer thickness corresponding to an edge treatment profile defined at 110. For example, where an edge treatment profile specifies a taper in thickness, cells of the edge profile table are filled with image values corresponding to that tapered thickness.

The indices of the 1-dimensional edge profile table are used above to define an edge treatment zone. The first N values of the edge profile table are passthrough values that transform the index to itself so that image values not being changed are passed through the transformation of the edge profile table. In one case, where grayscale image values are used, the first 256 values of the edge profile table will contain grayscale image values (0-255). In one case, the 257^{th} value of the edge profile table can be used to return the thickness of the base layer. In another case, if the image scale has 1000 values, corresponding to fractional thickness between a minimum value and a maximum value, the first 1000 values (indices 0-999) of the edge profile table will be passthrough values (0-999), and edge treatment values (e.g. values between 0 and 999) can be placed in the edge profile table at index values above 1000. If any cells of the edge profile table beyond the cells used to specify the edge treatment are unused, those cells can be populated with a “maximum” thickness value, for example “999” in the image scale above, to reflect no change to the original film thickness at those pixels. Where an image scale is used, any suitable image scale that provides resolution needed to specify various thicknesses to be formed can be used

Referring again to FIG. 1, the image value entries for the edge profile table are determined from the edge treatment profile defined at 110. If an image scale of 0 to 999 is used to represent thickness, and a taper from 100% thickness at 50 μm from the edge of the film to 50% thickness at 10 μm from the edge of the film is specified, with a pixel size of 10 μm, five image values will be needed to specify the taper, an image value corresponding to the film thickness from 0 μm to 10 μm from the edge of the film, and image values for 10-20 μm, 20-30 μm, 30-40 μm, and 40-50 μm. If the image value for 100% thickness is 999 and the image value for 50% thickness is 499 (basically percent thickness×10−1), the image values for the various locations are as follows:

| | |
|---|---|
| 0-10 μm | 499 |
| 10-20 μm | 599 |
| 20-30 μm | 699 |
| 30-40 μm | 799 |
| 40-50 μm | 899. |

Beyond 50 μm, the image values are 100% (i.e. 999). These image values are put into the edge profile table, at indices to be defined below.

The user-defined dimension of the edge treatment zone determines how many of the indices of the edge profile table are to be used to express the edge treatment profile. In one case, the width of the edge treatment zone is compared with the width of the edge profile basis. Roughly speaking, if the width of the edge treatment zone is 40% of the width of the edge profile basis, 40% of the entries of the edge profile table available to define the edge treatment might be populated with changed image values, depending on the specification of the edge treatment profile. Thus, in the example above where the edge profile table has 1000 entries that might be used to specify edge treatment, if the width of the edge treatment zone defined by the user is 100 μm (and the width of the edge profile basis is 10 mm 10,000 μm), then 1% of the cells in the edge profile table, or 10 cells, might be used to define the edge treatment. Where the edge treatment profile does not utilize all the defined width of the edge treatment zone, that number might be fewer, as above where only five image values are needed to specify the edge treatment. Thus, in that case, the edge profile table will have N cells with passthrough image values, optionally 1 cell (at index N+1) with an image value of the base layer thickness, and 5 cells having image values representing edge treatment of the base layer. The rest of the cells in the edge profile table are set to “maximum”. So, in the above example, the first 1000 entries of the edge profile table will be populated with values of 0 to 999, the next entry can be populated with a value of 1000 (to represent “base layer thickness”), and the next five entries can be populated with values of 499, 599, 699, 799, and 899. Beyond that, the rest of the cells in the edge profile table can be populated with values of 999. This table, constructed this way, can be used as a look-up table to find the image values to apply the edge treatment to the base layer in the corresponding edge treatment zone.

As noted above, the map table is initialized, in the areas covered by the edge profile basis, with indices to be used to look-up image values in an edge profile table. The edge profile table is populated with image values representing a selected edge profile in the above operations. At 114, cells from the map table corresponding to the edge treatment zone are read to obtain indices for look-up in the edge profile table. Image values are obtained from the edge profile table using the obtained indices. At 116, an image table is populated with the image values obtained from the look-up operation using the edge profile table. The image table has the same dimensions as the edge treatment zone or the edge profile basis, and corresponds to the area selected or defined by the user to apply an edge treatment. After the process 116 is performed for all locations within the edge treatment zone, the image table contains image values for the film thickness within the edge treatment zone.

Using a separate image table enables other processes that can be valuable. For example, where multiple edge treatments are contemplated for one layer, each edge treatment can be processed separately into its own image table, and then the individual image tables can be combined into an overall image table for the final layer specification. In such cases, each edge treatment zone acts as a mask to capture pixels of the base layer falling within the respective edge treatment zone. The edge treatment zones can be combined and used as a reverse mask to capture the pixels of the base layer not falling in any edge treatment zone as well. A similar look-up table process can be employed to adjust values and correct errors in the image values representing the areas of the base layer not falling within an edge treatment zone. Where multiple image tables are created in this way, the values of the image tables can be converted from 8-bit values to floating point values, added together using simple addition, and then converted back to 8-bit values to yield a composite image table representing the final edge compensated layer. The final 8-bit image can then be processed, using known methods, into print data for operation of a printer to deposit print material to form the layer.

The methods and means described herein are implemented using a digital processing system that has a processor, a memory, a display, and an input. The digital processing system can have multiple instances or units of each functional part. The various files and tables described herein can be stored in the memory for retrieval and manipulation by a user using the input, which can be a keyboard, touch screen, drawing device, or other input or combination of inputs. The data, shapes, and interactive objects described herein can be displayed on the screen for user manipulation. The digital processing system can also have communication with other systems, for instance enterprise systems or manufacturing systems that control and operate film formation equipment such as inkjet printers. The digital processing system can be used to display all the graphical interface elements described above, accept user input, as shape definitions and/or files using any of the inputs of the digital processing system, and store data relating to the layer design and the edge treatments defined by the user in a memory of the digital processing system. The image table described above, in particular, can be stored in the digital memory and used to create printer control data to form the layer designed using the methods and graphical user interfaces described herein.

While the foregoing is directed to embodiments of one or more inventions, other embodiments of such inventions not specifically described in the present disclosure may be devised without departing from the basic scope thereof, which is determined by the claims that follow. The embodiments described herein are examples that illustrate the inventions. Other examples embodying the same inventions can be conceived from the descriptions herein.

1. A method of defining edge treatment of a layer of material to be formed on a substrate by inkjet printing, the method comprising:
obtaining a base image;
defining a raster pixelation of the base image;
populating a map table with indices of an edge profile table;
defining an edge treatment zone using the raster pixelation;
defining an edge treatment profile representing a thickness profile to be applied to the layer at an edge thereof;
populating the edge profile table with image values representing the edge treatment profile;
obtaining the indices from cells of the map table corresponding to the edge treatment zone;
retrieving an image value from the edge profile table for each index obtained from the map table; and
storing the image values in an image file.

2. The method of claim 1, wherein the edge profile table is a 1-dimensional table.

3. The method of claim 1, wherein the edge profile table is also populated with passthrough values.

4. The method of claim 1, wherein the edge treatment zone is a first edge treatment zone, the indices are a first set of indices, and the image file is a first image file, and further comprising:
defining a second edge treatment zone using the raster pixelation;
obtaining a second set of indices from cells of the map table corresponding to the second edge treatment zone;
retrieving an image value from the edge profile table for each index of the second set of indices; and
storing the image value retrieved for each index of the second set of indices in a second image file.

5. The method of claim 4, further comprising
defining a third image file from the map table using the first edge treatment zone and the second edge treatment zone as a mask; and
adding the first image file, the second image file, and the third image file to form a composite image file of the layer; and
storing the composite image file.

6. The method of claim 1, further comprising defining an edge basis profile and populating a map table with indices of an edge profile table is performed using the edge basis profile.

7. The method of claim 1, wherein the image values are values from a scale.

8. The method of claim 1, wherein defining the edge treatment zone comprises accepting user input of an edge treatment zone using a drawing function of a graphical user interface.

9. The method of claim 1, further comprising transforming the image file into print data for an inkjet printer.

10. A method of defining edge treatment of a layer of material to be formed on a substrate by inkjet printing, the method comprising:
displaying a base image of the layer on a display of a digital processing system;
accepting user input of an edge treatment zone, defined using a raster pixelation, from an input of the digital processing system;
accepting user input of an edge treatment profile, representing a thickness profile to be applied to the layer at an edge thereof, from the input of the digital processing system; and
using the digital processing system to,
define the raster pixelation of the base image;
populate a map table with indices of an edge profile table;
populate the edge profile table with image values representing the edge treatment profile;
obtain the indices from cells of the map table corresponding to the edge treatment zone;
retrieve an image value from the edge profile table for each index obtained from the map table; and
store the image values in an image file.

11. The method of claim 10, further comprising displaying, on the display of the digital processing system, a graphical representation of the edge treatment profile.

12. The method of claim 10, further comprising displaying, on the display of the digital processing system, a graphical representation of the edge treatment zone.

13. The method of claim 10, wherein the user input of the edge treatment zone is a shape definition created by the user.

14. The method of claim 10, wherein the user input of the edge treatment zone is a digital file created by the user.

15. The method of claim 10, further comprising, in response to a user selection, displaying data of the base image, the map table, and the edge profile table,

16. A method of defining edge treatment of a layer of material to be formed on a substrate by inkjet printing, the method comprising:
obtaining a base image;
defining a raster pixelation of the base image;
populating a map table with indices of an edge profile table;
accepting digital user input defining an edge treatment zone based on the raster pixelation;
accepting digital user input defining an edge treatment profile, the edge treatment profile representing a thickness profile to be applied to the layer at an edge thereof;
populating the edge profile table with image values representing the edge treatment profile;
obtaining the indices from cells of the map table corresponding to the edge treatment zone;
retrieving an image value from the edge profile table for each index obtained from the map table;
depositing the image values in an image table; and
outputting the image table to an image file.

17. The method of claim 16, wherein the edge treatment zone is a first edge treatment zone, the indices are a first set of indices, the image values are first image values, the image table is a first image table, and the image file is a first image file, and further comprising:
accepting digital user input defining a second edge treatment zone based on the raster pixelation;
obtaining a second set of indices from cells of the map table corresponding to the second edge treatment zone;
retrieving a second image value from the edge profile table for each index of the second set of indices;
depositing the second image values in a second image table; and
outputting a combination of the first image table and the second image table to the image file.

18. The method of claim 17, further comprising:
defining a third image table from the map table using the first edge treatment zone and the second edge treatment zone as a mask; and
adding the first image table, the second image table, and the third image table to form a composite image table of the layer; and
outputting the composite image table to the image file.

19. The method of claim 17, wherein the edge profile table is a 1-dimensional table that also contains passthrough values.

20. The method of claim 17, wherein the image values are values from a scale.

21. The method of claim 17, further comprising transforming the image file into print data for an inkjet printer.
